(19) United States
(12) Patent Application Publication
(10) Pub. No.: US 2013/0004845 A1
(43) Pub. Date: Jan. 3, 2013

(54) LITHIUM SECONDARY BATTERY

(76) Inventors: Takumi Tamaki, Nisshin-shi (JP); Kaoru Inoue, Hirakata-shi (JP)

(21) Appl. No.: 13/634,325

(22) PCT Filed: Mar. 15, 2010
(86) PCT No.: PCT/JP2010/054369

§ 371 Date: Sep. 12, 2012

(51) Int. Cl. H01M 4/64

(52) U.S. Cl. 429/211

(57) ABSTRACT

A lithium secondary battery according to the present invention comprises a cathode and an anode 20. The anode 20 is structured such that an anode active material layer 24 containing anode active materials 21a and 21b is retained on an anode collector 22. The anode active material layer 24 has a structure of at least two layers: a collector-side active material layer 24a provided on the anode collector 22; and a surface-side active material layer 24b provided on the collector-side active material layer 24a. An average specific surface area of the anode active material 21b contained in the surface-side active material layer 24b is greater than an average specific surface area of the anode active material 21a contained in the collector-side active material layer 24a, and an average specific surface area of the anode active materials contained in the entire anode active material layer 24 is 3.3 m²/g to 5.6 m²/g.

### TECHNICAL FIELD

The present invention relates to a lithium secondary battery, and more specifically, to a lithium secondary battery with improved durability against charge-discharge cycles.

### BACKGROUND ART

In recent years, lithium-ion batteries, nickel hydride batteries, and other secondary batteries have grown in importance as vehicle-mounted power supplies or as power supplies for personal computers and mobile phones. In particular, lithium-ion batteries that are lightweight and capable of achieving a high energy density are expected to become favorably used as a vehicle-mounted, high-output power supply. With a lithium-ion battery, charging and recharging are performed as a result of lithium ions traveling back and forth between a cathode and an anode. Patent Literature 1 to Patent Literature 3 are examples of prior art related to lithium-ion batteries.

### CITATION LIST

### Patent Literature

Patent Literature 1: Japanese Patent Application Laid-Open No. 2009-64574
Patent Literature 2: Japanese Patent Application Laid-Open No. 2008-234852
Patent Literature 3: WO 2008/93724

Applications of a lithium-ion battery include those in which the lithium-ion battery is conceivably used in a mode where charging and recharging is repetitively performed at a high rate (rapid charge-discharge). A lithium-ion battery that is used as a power source of a vehicle (for example, a lithium-ion battery mounted on a hybrid vehicle that concomitantly uses, as power sources, a lithium-ion battery and another power source with a different operating principle such as an internal-combustion engine) is an representative example of a lithium-ion battery with such a conceivable mode of use. However, although conventional general lithium-ion batteries are known for relatively high durability with respect to low-rate charge-discharge cycles, they are also known to be susceptible to performance degradation (an increase in internal resistance and the like) in a charge-discharge pattern in which high-rate charge-discharge is repeated.

Patent Literature 1 describes a technique that aims to improve charge rate characteristics and cycle characteristics by forming a first anode layer made of artificial graphite on an anode collector, and forming a second anode layer made of natural graphite which has a greater specific surface area than artificial graphite on top of the first anode layer. However, even with this technique, durability against a charge-discharge pattern in which rapid charge-discharge is repeated at a level required by a lithium-ion battery or the like of a vehicle power source (for example, high-rate charge-discharge of 6 C or more) cannot be improved.

### SUMMARY OF INVENTION

The present invention has been made in consideration of the above, and a primary object thereof is to provide a lithium secondary battery with improved durability against high-rate charge-discharge.

The present inventors focused on a phenomenon of a significant deterioration in battery capacity which is observed when continuously repeating discharging and charging for short periods of time (pulse-like) at a high rate such as that assumed with a lithium secondary battery for a vehicle power source. Therefore, an effect of repetitively performed high-rate pulse charge-discharge on a lithium secondary battery was analyzed in detail.

As a result, it was found that, with a lithium secondary battery on which high-rate pulse charge-discharge has been repetitively performed, lithium deposition occurs on a surface side (a side opposite to a collector) of an anode active material layer. More specifically, when used under high-rate pulse charge-discharge, an electrode reaction (a Li ion insertion reaction) may not proceed efficiently on a collector side of the anode active material layer and may proceed disproportionately on a surface side of the anode active material layer. When such an imbalance in the electrode reaction becomes significant, Li ions emitted from a cathode active material layer may not all enter the surface side of the anode active material layer and deposition of the Li ions may occur on the surface of the anode active material layer.

Such a deposition of Li may cause a decline in durability of the battery (deterioration of a battery capacity). In particular, since reactivity of the anode active material (typically, activity of a Li ion insertion reaction) and diffusivity of Li ions within the anode active material layer tend to drop during high-rate pulse charge-discharge at low temperatures, a likelihood of the decline in durability (deterioration of the battery capacity) described above increases.

Based on the above teachings, the present invention is designed to improve durability of a lithium secondary battery against high-rate charge-discharge cycles by adopting an approach of resolving or mitigating deposition of Li on a surface side of the anode active material layer.

Specifically, a lithium secondary battery (for example, a lithium-ion battery) provided by the present invention comprises a cathode and an anode, wherein the anode is structured such that an anode active material layer containing anode active materials is retained on an anode collector. The anode active material layer has a structure of at least two layers: a collector-side active material layer provided on the anode collector; and a surface-side active material layer provided on the collector-side active material layer. In addition, an average specific surface area of the anode active material contained in the surface-side active material layer is greater than an average specific surface area of the anode active material contained in the collector-side active material layer, and an average specific surface area of the anode active materials contained in the entire anode active material layer is 3.3 m²/g to 5.6 m²/g.

The average specific surface area of the anode active materials (typically, particulate) contained in the anode active material layer can be measured using, for example, a BET method based on nitrogen gas adsorption. An average specific surface area measurement by the BET method can be performed using, for example, a commercially-available specific surface area measuring device (ASAP 2010) by Micromeritics Instrument Corporation.

According to the present invention, since the average specific surface area of the anode active material contained in the surface-side active material layer is set greater than the average specific surface area of the anode active material contained in the collector-side active material layer, the reactivity of the anode active material (typically, the activity of a Li ion insertion reaction) on the surface side of the anode active material layer becomes higher than that on the collector side, and Li ions emitted from the cathode active material layer due to a high-rate charge-discharge become more likely to enter the anode active material on the surface side of the anode active material layer. Accordingly, deposition of lithium due to high-rate charge-discharge is resolved or mitigated, and durability against high-rate charge-discharge cycles can be improved.

In this case, when attempting to increase the reactivity of the anode active materials by increasing the average specific surface area of the anode active materials contained in the entire anode active material layer (both the surface-side active material layer and the collector-side active material layer) in order to suppress the deposition of lithium, paradoxically, the anode active materials and an electrolyte react in a hot environment and capacity retention after high temperature storage declines.

Therefore, according to the present invention, while maintaining the average specific surface area of the anode active materials of the entire anode active material layer to 3.3 m²/g to 5.6 m²/g, the specific surface area of the surface side of the anode active material layer (the surface-side active material layer) on which lithium deposition is particularly prominent is set greater than the collector side (the collector-side active material layer). In this manner, by providing an appropriate difference in specific surface areas of the anode active materials between the surface side and the collector side and appropriately adjusting a relationship between reactivity (activity of a Li ion insertion reaction) of both anode active materials, high-temperature storage characteristics of an entire anode can be favorably maintained and, at the same time, the deposition of lithium on the surface side of the anode active material layer can be suppressed. Therefore, according to the present invention, a high-performance lithium secondary battery that achieves both high-temperature storage characteristics and high-rate charge-discharge cycle durability at a high level can be provided.

The average specific surface area of the anode active materials contained in the entire anode active material layer is approximately 3.3 m²/g to 5.6 m²/g. Exceeding this range may result in a decline of high-temperature storage characteristics of the entire anode. Therefore, from the perspective of improving high-temperature storage characteristics, the average specific surface area of the anode active materials contained in the entire anode active material layer is appropriately set to 5.6 m²/g or less, favorably set to, for example, 5.0 m²/g or less, more favorably set to, for example, 4.5 m²/g or less, and further favorably set to, for example, 4.0 m²/g or less. A lower limit value of the average specific surface area is approximately 3.3 m²/g. Falling below this range may result in a failure to sufficiently produce an effect of improving durability against high-rate charge-discharge cycles.

In a favorable mode of a lithium secondary battery disclosed herein, the average specific surface area of the anode active material contained in the surface-side active material layer is 6.0 m²/g to 8.0 m²/g. Falling below this range may result in a failure to sufficiently produce an effect of suppressing lithium deposition on the surface side of the anode active material layer, while exceeding this range may result in a decline of high-temperature storage characteristics of the entire anode. Therefore, the average specific surface area of the anode active material contained in the surface-side active material layer is appropriately set to approximately 6.0 m²/g to 8.0 m²/g.

In a favorable mode of a lithium secondary battery disclosed herein, the average specific surface area of the anode active material contained in the collector-side active material layer is 2.5 m²/g to 4.5 m²/g. Falling below this range may result in an occurrence of lithium deposition on the collector side of the anode active material layer, while exceeding this range may result in a decline of high-temperature storage characteristics of the entire anode. Therefore, the average specific surface area of the anode active material contained in the collector-side active material layer is appropriately set to approximately 2.5 m²/g to 4.5 m²/g.

In a favorable mode of a lithium secondary battery disclosed herein, the anode active materials are each composed of a carbon-based material. While a carbon-based material has a favorable property as an anode active material, a carbon-based material also has a property in which lithium deposition readily occurs when used under high-rate pulse charge-discharge. Therefore, when the anode active materials are each composed of a carbon-based material, by providing an appropriate difference in specific surface areas of the anode active materials between the surface side and the collector side to appropriately adjust the reactivity of the anode active materials, an operational effect of a configuration of the present invention in which durability against high-rate charge-discharge cycles is improved while maintaining preferable high-temperature storage characteristics of the entire anode can be achieved in a favorable manner.

The present invention also provides the anode provided in the lithium secondary battery described above. In other words, the present invention provides an anode for a lithium secondary battery structured such that an anode active material layer containing anode active materials is retained on an anode collector, wherein the anode active material layer has a structure of at least two layers: a collector-side active material layer provided on the anode collector; and a surface-side active material layer provided on the collector-side active material layer, an average specific surface area of the anode active material contained in the surface-side active material layer is greater than an average specific surface area of the anode active material contained in the collector-side active material layer, and an average specific surface area of the anode active materials contained in the entire anode active material layer is 3.3 m²/g to 5.6 m²/g.

Examples of favorable objects of application of the techniques disclosed herein include: a lithium secondary battery which can conceivably be used in a charge-discharge cycle including a high-rate charge-discharge of 50 A or higher (for example, 50 A to 250 A) and, more specifically, 100 A or higher (for example, 100 A to 200 A); and a high-capacity lithium secondary battery which has a theoretical capacity of 3 Ah or greater (more specifically, 5 Ah or greater) and which may conceivably be used in a charge-discharge cycle including a high-rate charge-discharge of 10 C or higher (for example, 10 C to 50 C), more specifically, 12 C or higher (for example, 12 C to 45 C), and further specifically 20 C or higher (for example, 20 C to 45 C).

Any of the lithium secondary batteries disclosed herein has a property suitable as a battery mounted on a vehicle (for example, an ability to produce high output) and, in particular, may be superior in durability against high-rate charge-discharge. Therefore, according to the present invention, a vehicle mounted with any of the lithium secondary batteries disclosed herein is provided. In particular, a vehicle (for example, an automobile) comprising the lithium secondary battery as a power source (typically, a power source of a hybrid vehicle or an electric vehicle) is provided.

### BRIEF DESCRIPTION OF DRAWINGS

FIG. 1 is a perspective view schematically showing a lithium secondary battery according to an embodiment of the present invention;

FIG. 2 is a cross sectional view taken along line II-II in FIG. 1;

FIG. 3 is a diagram schematically showing an electrode of a lithium secondary battery according to an embodiment of the present invention;

FIG. 4 is a plan view schematically showing an electrode of a lithium secondary battery according to an embodiment of the present invention;

FIG. 5 is an enlarged sectional view showing substantial parts of a lithium secondary battery according to an embodiment of the present invention;

FIG. 6 is a diagram schematically showing a lithium secondary battery (laminated cell) according to examples and comparative examples;

FIG. 7 is a graph showing a relationship between an average specific surface area and a limiting current rate of an entire anode according to examples and comparative examples;

FIG. 8 is a graph showing a relationship between an average specific surface area and a limiting current rate of an entire anode according to examples and comparative examples;

FIG. 9 is a graph showing a relationship between an average specific surface area and high temperature capacity retention of an entire anode according to examples and comparative examples; and

FIG. 10 is a side view schematically showing a vehicle comprising a lithium secondary battery according to an embodiment of the present invention.

### DESCRIPTION OF EMBODIMENTS

Hereinafter, an embodiment of the present invention will be described with reference to the drawings. In the following drawings, members/portions producing a same effect are described denoted by a same reference numeral. Moreover, dimensional relationships (length, width, thickness, and the like) shown in the respective drawings do not reflect actual dimensional relationships. In addition, any technological matters not specifically mentioned in the present specification but necessary to the implementation of the present invention (for example, a configuration and a method of manufacturing an electrode comprising a cathode and an anode, a configuration and a method of manufacturing a separator or an electrolyte, and general techniques related to the construction of a lithium secondary battery and other batteries) can be construed as design items for a person skilled in the art on the basis of prior art in the relevant field.

Although not particularly intended to be limiting, the present invention will be described in detail below using an example of a lithium secondary battery (lithium-ion battery) configured such that a flat-wound electrode body (wound electrode body) and a nonaqueous electrolyte are housed in a flat, box-like (rectangular parallelepiped shape) container.

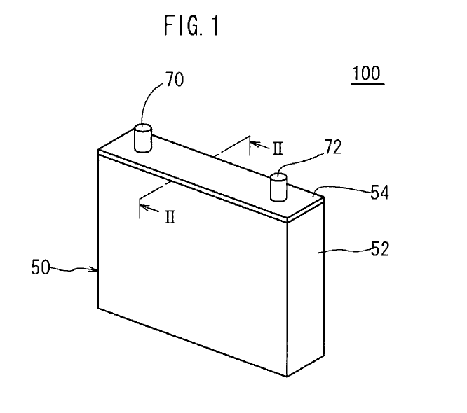

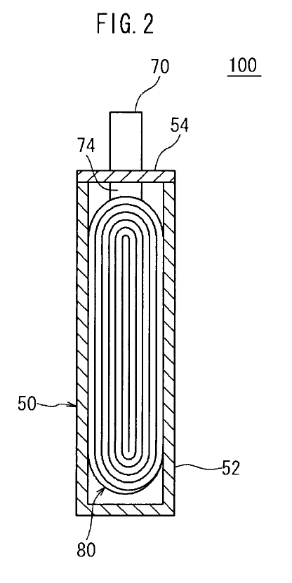

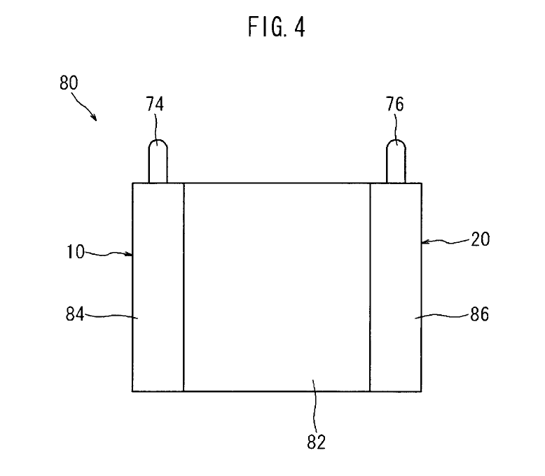

A schematic configuration of a lithium-ion battery according to an embodiment of the present invention is shown in FIGS. 1 to 4. The lithium-ion battery 100 has a structure in which an electrode body (wound electrode body) 80 configured such that an elongated cathode sheet 10 and an elongated anode sheet 20 are flatly wound via an elongated separator 40 is housed together with a nonaqueous electrolyte (not shown) in a container 50 with a shape (a flat box shape) capable of housing the wound electrode body 80.

The container 50 comprises a flat rectangular parallelepiped-shaped container main body 52 having an open upper end, and a lid body 54 that blocks the opening thereof. As a material that constitutes the container 50, a metallic material such as aluminum and steel is favorably used (aluminum is used in the present embodiment). Alternatively, the container 50 may be molded from a resin material such as PPS or polyimide resin. A cathode terminal 70 that is electrically connected to a cathode of the wound electrode body 80 and an anode terminal 72 that is that is electrically connected to an anode 20 of the electrode body 80 are provided on an upper surface of the container 50 (in other words, on the lid body 54). The flat-shaped wound electrode body 80 is housed together with a nonaqueous electrolyte (not shown) inside the container 50.

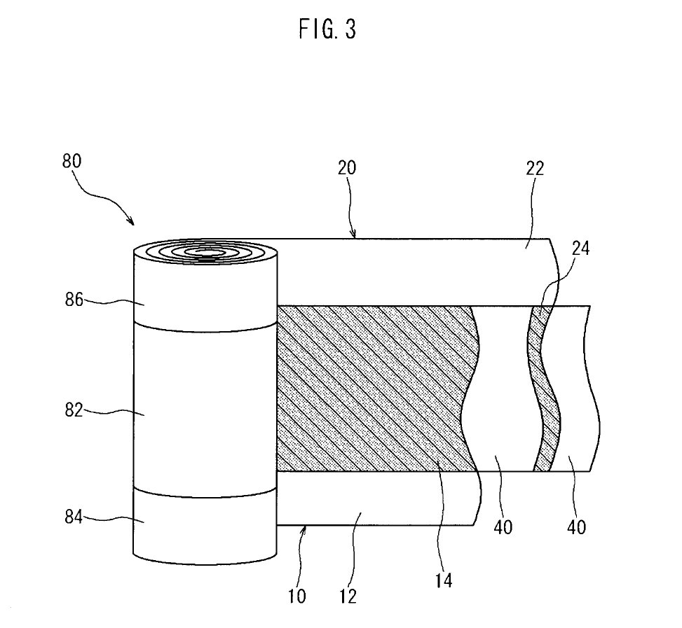

The wound electrode body 80 according to the present embodiment is similar to a wound electrode body of an ordinary lithium-ion battery with the exception of a configuration of a layer (anode active material layer) which contains anode active materials and which is provided on an anode sheet 20 (to be described later) and, as shown in FIG. 3, has an elongated (band-shaped) sheet structure prior to assembly of the wound electrode body 80.

The anode sheet 20 has a structure in which an anode active material layer 24 containing anode active materials is retained on both surfaces of an elongated sheet-shaped foil-like anode collector (hereinafter referred to as an “anode collector foil”) 22. However, the anode active material layer 24 is not attached to one side edge (an upper side edge portion in the drawing) along an end side of the anode sheet 20 in a width direction, and an anode active material layer unformed section is formed in which the anode collector 22 is exposed at a constant width.

In a similar manner to the anode sheet 20, the cathode sheet 10 has a structure in which a cathode active material layer 14 containing cathode active materials is retained on both surfaces of an elongated sheet-shaped foil-like cathode collector (hereinafter referred to as an “cathode collector foil”) 12. However, the cathode active material layer 14 is not attached to one side edge (a lower side edge portion in the drawing) along an end side of the cathode sheet 10 in a width direction, and a cathode active material layer unformed section is formed in which the cathode collector 12 is exposed at a constant width.

When fabricating the wound electrode body 80, the cathode sheet 10 and the anode sheet 20 are laminated via the separator sheet 40. In doing so, the cathode sheet 10 and the anode sheet 20 are overlapped slightly displaced in a width direction so that the cathode active material layer unformed section of the cathode sheet 10 and the anode active material layer unformed section of the anode sheet 20 respectively protrude from both sides of the separator sheet 40 in the width direction. The flat wound electrode body 80 can be fabricated by winding a laminated body that is overlapped as described above and then crushing and flattening the obtained wound body from a side surface direction.

A wound core portion 82 (that is, a portion in which the cathode active material layer 14 of the cathode sheet 10, the anode active material layer 24 of the anode sheet 20, and the separator sheet 40 are tightly laminated) is formed in a central portion of the wound electrode body 80 in a winding axis direction. In addition, the electrode active material layer unformed sections of the cathode sheet 10 and the anode sheet 20 respectively protrude outward from the wound core portion 82 at both ends of the wound electrode body 80 in the winding axis direction. A cathode lead terminal 74 and an anode lead terminal 76 are respectively annexed to the cathode-side protruding portion (in other words, the unformed portion of the cathode active material layer 14) 84 and the anode-side protruding portion (in other words, the unformed portion of the anode active material layer 24) 86, and are respectively electrically connected to the cathode terminal 70 and the anode terminal 72 described above.

Components constituting the wound electrode body 80 may be similar to those of a wound electrode body of a conventional lithium-ion battery with the exception of the anode sheet 20, and are not particularly limited. For example, the cathode sheet 10 can be formed by attaching a cathode active material layer 14 composed mainly of lithium-ion battery cathode active materials on top of an elongated cathode collector 12. An aluminum foil or other metallic foils suitable for a cathode is preferably used as the cathode collector 12.

One or two or more types of materials conventionally used in a lithium-ion battery can be used as the cathode active material without any particular limitation. Preferred examples include cathode active materials composed mainly of an oxide that includes lithium and a transition metal element as constituent metal elements (a lithium-transition metal oxide) such as lithium-nickel oxide (LiMn₂O₄), lithium-cobalt oxide (LiCoO₂), and lithium-manganese oxide (LiNiO₂). In particular, a cathode active material composed mainly of a lithium-nickel-cobalt-manganese complex oxide (for example, LiNi_{1/3}Co_{1/3}Mn_{1/3}O₂) (typically, a cathode active material substantially consisting of a lithium-nickel-cobalt-manganese complex oxide) is favorably applied.

In this case, in addition to oxides having Li, Ni, Co, and Mn as constituent metal elements, a lithium-nickel-cobalt-manganese complex oxide is defined so as to encompass oxides including at least one another metal element besides Li, Ni, Co, and Mn (in other words, a transition metal element and/or a typical metal element other than Li, Ni, Co, and Mn). The metal element may be one or two or more elements selected from the group consisting of, for example, B, V, Mg, Sr, Zr, Mo, W, Ti, Al, Cr, Fe, Nb, Cu, Zn, Ga, In, Sn, La, and Ce. The same applies to a lithium-nickel oxide, a lithium-cobalt oxide, and a lithium-manganese oxide.

The anode sheet 20 can be formed by attaching an anode active material layer 24 composed mainly of lithium-ion battery anode active materials on top of an elongated anode collector 22. A copper foil or other metallic foils suitable for an anode is preferably used as the anode collector 22.

The anode active material layer 24 may contain, as necessary, one or two or more types of materials usable in a general lithium-ion battery as components of an anode active material layer. Examples of such materials include various polymer materials (for example, styrene-butadiene rubber (SBR)) capable of functioning as a binder of the anode active materials described above. Other examples of materials usable as a component of the anode active material layer include various polymer materials (for example, carboxymethyl cellulose (CMC)) capable of functioning as a thickener.

Although not particularly limited thereto, a proportion of anode active materials in an entire anode active material layer is favorably approximately 95 percent by mass or higher (typically, from 97 percent by mass to 99 percent by mass), and more favorably from approximately 98 percent by mass to 99 percent by mass. In addition, when containing an anode active material layer forming component (for example, a polymer material such as a binder or a thickener) other than an anode active material, a total content percentage of such arbitrary components is favorably 5 percent by mass or lower, and more favorably 3 percent by mass or lower (for example, from 1 percent by mass to 2 percent by mass).

As a method of forming the anode active material layer 24, a method can be favorably adopted in which an anode active material layer forming paste created by dispersing an anode active material (typically, granular) and other anode active material layer forming components in an appropriate solvent (favorably, an aqueous solvent) is applied in a band shape on one surface or both surfaces of the anode collector 22 and then dried. After the anode active material layer forming paste is dried, by performing an appropriate pressing process (for example, various conventional and known pressing methods such as a roll pressing method and a flat-plate pressing method can be adopted), a thickness and a density of the anode active material layer 24 can be adjusted.

Examples of a preferable separator sheet 40 used between the cathode and anode sheets 10 and 20 include a separator sheet composed of a porous polyolefin-type resin. For example, a porous separator sheet made of a synthetic resin (for example, made of polyolefin such as polyethylene) can be preferably used. Moreover, when a solid electrolyte or a gel electrolyte is used as the electrolyte, the separator may become unnecessary (in other words, in this case, the electrolyte itself may function as a separator).

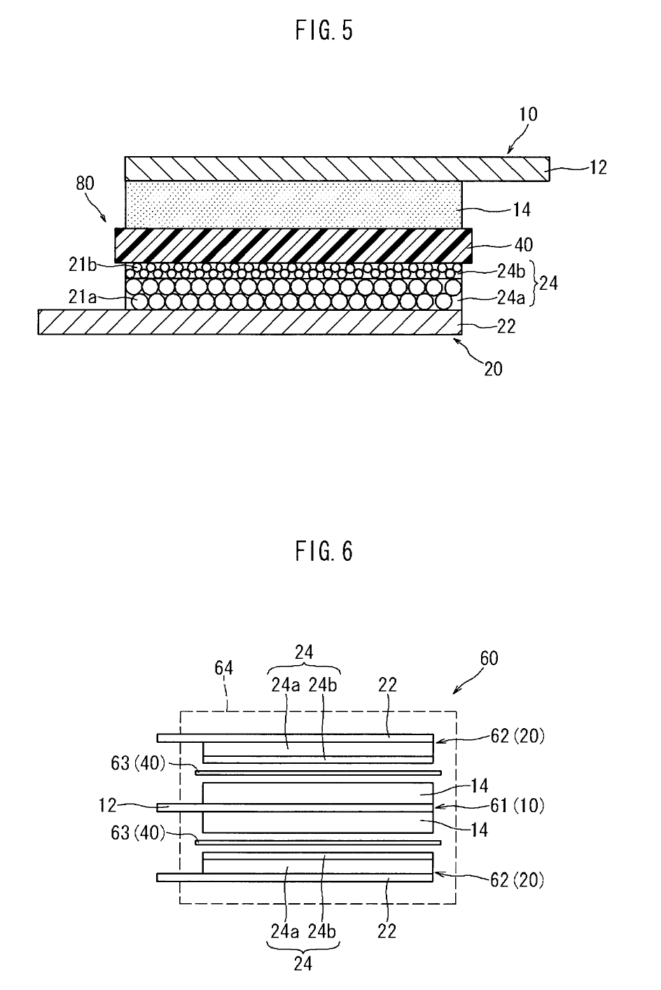

Next, with additional reference to FIG. 5, the anode sheet 20 according to the present embodiment will be described in detail. FIG. 5 is a schematic cross-sectional view showing an enlargement of a part of a cross section of the wound electrode body 80 along the winding axis according to the present embodiment. FIG. 5 shows the anode collector 22 and the anode active material layer 24 formed on one side thereof, the separator sheet 40 opposing the anode active material layer 24, and the cathode sheet 10 (the cathode active material layer 14 and the cathode collector 12).

As shown in FIG. 5, the anode active material layer 24 according to the present embodiment has a structure of at least two layers: a collector-side active material layer 24a provided on the anode collector 22; and a surface-side active material layer 24b provided on the collector-side active material layer 24a. In the present embodiment, both the collector-side active material layer 24a and the surface-side active material layer 24b are constructed using anode active materials consisting of a carbon material. In addition, the collector-side active material layer 24a and the surface-side active material layer 24b are constructed such that an average specific surface area of an anode active material 21b contained in the surface-side active material layer 24b is greater than an average specific surface area of an anode active material 21a contained in the collector-side active material layer 24a.

In this manner, by setting the average specific surface area of the anode active material 21b in the surface-side active material layer 24b greater than the average specific surface area of the anode active material 21a in the collector-side active material layer 24a, a reactivity of the anode active material (typically, an activity of a Li ion insertion reaction) on the surface side of the anode active material layer becomes higher than that on the collector side, and Li ions emitted from the cathode active material layer due to a high-rate charge-discharge become more likely to enter the anode active material 21b on the surface side of the anode active material layer. Accordingly, deposition of lithium due to high-rate charge-discharge can be resolved or mitigated, and durability against high-rate charge-discharge cycles can be improved.

In this case, when attempting to increase the reactivity of the anode active materials by increasing the average specific surface area of the anode active materials contained in the entire anode active material layer (both the surface-side active material layer and the collector-side active material layer) in order to suppress the deposition of lithium, paradoxically, the anode active materials and an electrolyte react in a hot environment and capacity retention after high temperature storage declines.

Therefore, according to the present embodiment, while maintaining the average specific surface area of the anode active materials contained in the entire anode active material layer to 3.3 m²/g to 5.6 m²/g, the specific surface area of the surface side of the anode active material layer (the surface-side active material layer 24b) on which lithium deposition is particularly prominent is set greater than the collector side (the collector-side active material layer 24a). In this manner, by providing an appropriate difference in specific surface areas of the anode active materials between the surface side and the collector side and appropriately adjusting a relationship of reactivity (activity of a Li ion insertion reaction) of the anode active materials between both sides, high-temperature storage characteristics of the entire anode can be favorably maintained and, at the same time, the deposition of lithium on the surface side of the anode active material layer 24 can be suppressed. Therefore, according to the present embodiment, a high-performance lithium secondary battery that achieves both high-temperature storage characteristics and high-rate charge-discharge cycle durability at a high level can be provided.

The average specific surface area of the anode active materials contained in the entire anode active material layer is approximately 3.3 m²/g to 5.6 m²/g. Exceeding this range may result in a decline of high-temperature storage characteristics of the entire anode. Therefore, from the perspective of improving high-temperature storage characteristics, the average specific surface area of the anode active materials contained in the entire anode active material layer is appropriately set to 5.6 m²/g or less, favorably set to, for example, 5.0 m²/g or less, more favorably set to, for example, 4.5 m²/g or less, and further favorably set to, for example, 4.0 m²/g or less. A lower limit value of the average specific surface area is approximately 3.3 m²/g. Falling below this range may result in a failure to sufficiently produce an effect of improving durability against high-rate charge-discharge cycles.

In addition, in a favorable mode disclosed herein, the average specific surface area of the anode active material contained in the surface-side active material layer is 6.0 m²/g to 8.0 m²/g. Falling below this range may result in a failure to sufficiently produce an effect of suppressing lithium deposition on the surface side of the anode active material layer, while exceeding this range may result in a decline of high-temperature storage characteristics of the entire anode. Therefore, the average specific surface area of the anode active material in the surface-side active material layer is appropriately set to approximately 6.0 m²/g to 8.0 m²/g.

Furthermore, in a favorable mode disclosed herein, the average specific surface area of the anode active material contained in the collector-side active material layer is 2.5 m²/g to 4.5 m²/g. Falling below this range may result in an occurrence of lithium deposition on the collector side of the anode active material layer, while exceeding this range may result in a decline of high-temperature storage characteristics of the entire anode. Therefore, the average specific surface area of the anode active material in the collector-side active material layer is appropriately set to approximately 2.5 m²/g to 4.5 m²/g.

The specific surface areas of the anode active material contained in the surface-side active material layer and the collector-side active material layer can be adjusted by, for example, appropriately selecting a particle size (a mean particle diameter) of the anode active materials. A magnitude of specific surface area can be grasped as a reverse relationship of a magnitude of particle size. In other words, as a particle size of the anode active material decreases, a specific surface area relatively increases. Therefore, by appropriately selecting the particle size of the anode active material used in the surface-side active material layer and the collector-side active material layer, the specific surface areas of the anode active material contained in the surface-side active material layer and the collector-side active material layer can be adjusted to the preferable ranges disclosed herein. Moreover, the average specific surface area of the anode active materials can be measured using, for example, a BET method based on nitrogen gas adsorption.

In a favorable mode disclosed herein, a mass of the anode active material contained in the surface-side active material layer is within 15 percent by mass to 45 percent by mass with respect to an entire mass of the anode active materials contained in the entire anode active material layer. Falling below this range may result in an occurrence of lithium deposition on the surface side of the anode active material layer, while exceeding this range may result in an excessive decline of high-temperature storage characteristics of the entire anode. Therefore, the mass (content) of the anode active material contained in the surface-side active material layer is appropriately set to within 15 percent by mass to 45 percent by mass with respect to the entire mass of the anode active materials contained in the entire anode active material layer, normally favorably set to within 20 percent by mass to 45 percent by mass, and more favorably set to within, for example, 25 percent by mass to 45 percent by mass.

In addition, in a favorable mode disclosed herein, a density of the surface-side active material layer is approximately equal to a density of the collector-side active material layer. By equalizing densities between the surface-side active material layer and the collector-side active material layer, a benefit of equalizing electrolyte permeability and liquid retention can be gained. Although not particularly limited thereto, the density of the surface-side active material layer and the collector-side active material layer is appropriately set to approximately 1.0 g/cm³ to 1.5 g/cm³, and favorably to, for example, 1.0 g/cm³ to 1.4 g/cm³. Moreover, while a thickness of the surface-side active material layer is not particularly limited, for example, the thickness is set to around 5 μm to 30 μm. In addition, while a thickness of the collector-side active material layer is not particularly limited, for example, the thickness is set to around 12 μm to 60 μm.

Formation of the anode active material layer having the two-layer structure described above can be performed by first forming the collector-side active material layer 24a on one surface or both surfaces of the anode collector 22 and then forming the surface-side active material layer 24b on the collector-side active material layer 24a. For example, the collector-side active material layer 24a is formed on the anode collector by applying a collector-side active material layer forming paste containing the anode active material 21a on one surface or both surfaces of the anode collector 22 in a band shape and then drying the collector-side active material layer forming paste. Next, a surface-side active material layer forming paste containing the anode active material 21b with a greater average specific surface area than the anode active material 21a is applied in a band shape on the collector-side active material layer 24a and then dried to form the surface-side active material layer 24b on the collector-side active material layer. The anode active material layer 24 having the two-layer structure described above can be obtained in this manner. After the drying, by performing an appropriate pressing process, a thickness and a density of the surface-side active material layer and the collector-side active material layer can be adjusted.

Moreover, according to the technique disclosed herein, a method can be provided for manufacturing an anode comprising, on an anode collector 22, an anode active material layer 24 which has a structure of at least two layers, namely, a collector-side active material layer 24a containing an anode active material 21a and a surface-side active material layer 24b containing an anode active material 21b with a greater average specific surface area than the anode active material 21a, and which is prepared such that an average specific surface area of all anode active materials is within 3.3 m²/g to 5.6 m²/g.

The manufacturing method comprises: forming the collector-side active material layer 24a containing the anode active material 21a on the anode collector 22; and forming the surface-side active material layer 24b containing the anode active material 21b with a greater average specific surface area than the anode active material 21a on the collector-side active material layer 24a. In addition, preparation is characteristically performed so that an average specific surface area of the anode active materials contained in the entire anode active material layer 24 combining the surface-side active material layer 24b and the collector-side active material layer 24a is within 3.3 m²/g to 5.6 m²/g. The anode 20 manufactured by this method is preferably usable as an anode for a lithium secondary battery.

A wound electrode body 80 configured as described above is housed in a container main body 52, and an appropriate nonaqueous electrolyte is arranged (introduced) into the container main body 52. As the nonaqueous electrolyte that is housed together in the container main body 52 with the wound electrode body 80, nonaqueous electrolytes similar to that used in a conventional lithium-ion battery can be used without any particular limitation. Such a nonaqueous electrolyte typically has a composition in which a supporting electrolyte is contained in an appropriate nonaqueous solvent. As the nonaqueous solvent described above, for example, ethylene carbonate (EC), ethyl methyl carbonate (EMC), dimethyl carbonate (DMC), diethyl carbonate (DEC), or propylene carbonate (PC) can be used. In addition, as the supporting electrolyte described above, for example, a lithium salt such as LiPF₆, LiBF₄, LiAsF₆, or LiCF₃SO₃ can be used. For example, a nonaqueous electrolyte in which LiPF₆ as a supporting electrolyte is contained at a concentration of approximately 1 mol/liter in a mixed solvent containing EC, EMC, and DMC at a volume ratio of 3:4:3 can be favorably used.

By housing the nonaqueous electrolyte together with the wound electrode body 80 in the container main body 52 and sealing an opening of the container main body 52 by welding the container main body 52 to a lid body 54 or the like, the construction (assembly) of the lithium-ion battery 100 according to the present embodiment is completed. Moreover, the sealing process of the container main body 52 and the arrangement (introduction) process of the electrolyte can be performed in a similar manner to methods used when manufacturing a conventional lithium-ion battery. Subsequently, conditioning (initial charging and discharging) of the battery is performed. Processes such as degassing and quality inspecting may be performed as necessary.

Hereinafter, the present invention will be described in further detail with reference to examples.

<Fabrication of Anode Sheet>

In the examples, the anode sheet 20 in which the collector-side active material layer 24a and the surface-side active material layer 24b are provided on the anode collector 22 was fabricated using a two-layer graphite material (in which a surface of spherical graphite is coated by a carbonaceous film) as the anode active material. These examples were adjusted so that an average specific surface area of the anode active material in the surface-side active material layer 24b is greater than an average specific surface area of the anode active material in the collector-side active material layer 24a.

Specifically, in example 1-1, a collector-side active material layer forming paste was prepared by mixing, in water, anode active material powder with an average specific surface area of 2.5 m²/g, styrene butadiene rubber (SBR) as a binder, and carboxymethyl cellulose (CMC) as a thickener so that a mass ratio of the materials is 98:1:1 and a solid content concentration of the materials is approximately 50 percent by mass, and by applying the collector-side active material layer forming paste on one surface of an elongated sheet-shaped copper foil (the anode collector 22) and drying the same, the collector-side active material layer 24a was formed on the anode collector 22. Moreover, the average specific surface area of the anode active material powder was measured using the commercially-available specific surface area measuring device (ASAP 2010) by Micromeritics Instrument Corporation.

Next, a surface-side active material layer forming paste was prepared by mixing, in water, anode active material powder with an average specific surface area of 7.0 m²/g, styrene butadiene rubber (SBR) as a binder, and carboxymethyl cellulose (CMC) as a thickener so that a mass ratio of the materials is 98:1:1 and a solid content concentration of the materials is approximately 50 percent by mass, and by applying the surface-side active material layer forming paste on the collector-side active material layer 24a and drying the same, the anode sheet 20 in which the surface-side active material layer 24b is provided on the collector-side active material layer 24a was obtained. After drying, pressing was performed so that both the collector-side active material layer 24a and the surface-side active material layer 24b acquired a density of approximately 1.0 g/cm³. Moreover, a total application quantity (weight per unit area) of the paste, which combines the surface-side active material layer forming paste and the collector-side active material layer forming paste, was adjusted to approximately 2.9 mg/cm² (based on solid content) per one surface. After pressing, a thickness of the collector-side active material layer was approximately 24 μm and a thickness of the surface-side active material layer was approximately 5 μm.

In addition, in example 1-2, an anode sheet was fabricated in a similar manner to example 1-1 with the exception of the thickness of the collector-side active material layer having been changed to approximately 20 μm and the thickness of the surface-side active material layer having been changed to approximately 9 μm. Furthermore, in example 1-3, an anode sheet was fabricated in a similar manner to example 1-1 with the exception of the thickness of the collector-side active material layer having been changed to approximately 17 μm and the thickness of the surface-side active material layer having been changed to approximately 12 μm.

In addition, in example 1-4, an anode sheet was fabricated in a similar manner to example 1-1 with the exception of the average specific surface area of the anode active material powder used in the collector-side active material layer having been changed to 4.5 m²/g and the average specific surface area of the anode active material powder used in the surface-side active material layer having been changed to 6.0 m²/g. Furthermore, in example 1-5, an anode sheet was fabricated in a similar manner to example 1-2 with the exception of the average specific surface area of the anode active material powder used in the collector-side active material layer having been changed to 4.5 m²/g and the average specific surface area of the anode active material powder used in the surface-side active material layer having been changed to 6.0 m²/g. In addition, in example 1-6, an anode sheet was fabricated in a similar manner to example 1-3 with the exception of the average specific surface area of the anode active material powder used in the collector-side active material layer having been changed to 4.5 m²/g and the average specific surface area of the anode active material powder used in the surface-side active material layer having been changed to 6.0 m²/g.

Furthermore, in example 2-1, an anode sheet was fabricated in a similar manner to example 1-1 with the exception of the density of the collector-side active material layer and the surface-side active material layer having been changed to approximately 1.4 g/cm³, the thickness of the collector-side active material layer having been changed to approximately 16 μm, and the thickness of the surface-side active material layer having been changed to approximately 12 μm. In addition, in example 2-2, an anode sheet was fabricated in a similar manner to example 2-1 with the exception of the thickness of the collector-side active material layer having been changed to approximately 14 μm and the thickness of the surface-side active material layer having been changed to approximately 7 μm. Furthermore, in example 2-3, an anode sheet was fabricated in a similar manner to example 2-1 with the exception of the thickness of the collector-side active material layer having been changed to approximately 12 μl and the thickness of the surface-side active material layer having been changed to approximately 9 μm.

In addition, in example 2-4, an anode sheet was fabricated in a similar manner to example 2-1 with the exception of the average specific surface area of the anode active material powder used in the collector-side active material layer having been changed to 4.5 m²/g and the average specific surface area of the anode active material powder used in the surface-side active material layer having been changed to 6.0 m²/g. Furthermore, in example 2-5, an anode sheet was fabricated in a similar manner to example 2-2 with the exception of the average specific surface area of the anode active material powder used in the collector-side active material layer having been changed to 4.5 m²/g and the average specific surface area of the anode active material powder used in the surface-side active material layer having been changed to 6.0 m²/g. In addition, in example 2-6, an anode sheet was fabricated in a similar manner to example 2-3 with the exception of the average specific surface area of the anode active material powder used in the collector-side active material layer having been changed to 4.5 m²/g and the average specific surface area of the anode active material powder used in the surface-side active material layer having been changed to 6.0 m²/g.

Furthermore, in example 3-1, an anode sheet was fabricated in a similar manner to example 1-1 with the exception of the total application quantity (weight per unit area) of paste, which combines the surface-side active material layer forming paste and the collector-side active material layer forming paste, having been adjusted to approximately 7.0 mg/cm² (based on solid content) per one surface, the thickness of the collector-side active material layer having been changed to approximately 60 μm, and the thickness of the surface-side active material layer having been changed to approximately 10 μm. In addition, in example 3-2, an anode sheet was fabricated in a similar manner to example 3-1 with the exception of the thickness of the collector-side active material layer having been changed to approximately 50 μm and the thickness of the surface-side active material layer having been changed to approximately 20 μm. Furthermore, in example 3-3, an anode sheet was fabricated in a similar manner to example 3-1 with the exception of the thickness of the collector-side active material layer having been changed to approximately 40 μm and the thickness of the surface-side active material layer having been changed to approximately 30 μm.

In addition, in example 3-4, an anode sheet was fabricated in a similar manner to example 3-1 with the exception of the average specific surface area of the anode active material powder used in the collector-side active material layer having been changed to 4.5 m²/g and the average specific surface area of the anode active material powder used in the surface-side active material layer having been changed to 7.0 m²/g. Furthermore, in example 3-5, an anode sheet was fabricated in a similar manner to example 3-2 with the exception of the average specific surface area of the anode active material powder used in the collector-side active material layer having been changed to 4.5 m²/g and the average specific surface area of the anode active material powder used in the surface-side active material layer having been changed to 7.0 m²/g. In addition, in example 3-6, an anode sheet was fabricated in a similar manner to example 3-3 with the exception of the average specific surface area of the anode active material powder used in the collector-side active material layer having been changed to 4.5 m²/g and the average specific surface area of the anode active material powder used in the surface-side active material layer having been changed to 7.0 m²/g.

Furthermore, in example 4-1, an anode sheet was fabricated in a similar manner to example 3-1 with the exception of the density of the collector-side active material layer and the surface-side active material layer having been changed to approximately 1.4 g/cm³, the thickness of the collector-side active material layer having been changed to approximately 43 μm, and the thickness of the surface-side active material layer having been changed to approximately 7 μm. In addition, in example 4-2, an anode sheet was fabricated in a similar manner to example 4-1 with the exception of the thickness of the collector-side active material layer having been changed to approximately 40 μm and the thickness of the surface-side active material layer having been changed to approximately 10 μm. Furthermore, in example 4-3, an anode sheet was fabricated in a similar manner to example 4-1 with the exception of the thickness of the collector-side active material layer having been changed to approximately 35 μm and the thickness of the surface-side active material layer having been changed to approximately 15 μm.

In addition, in example 4-4, an anode sheet was fabricated in a similar manner to example 4-1 with the exception of the average specific surface area of the anode active material powder used in the collector-side active material layer having been changed to 4.5 m²/g and the average specific surface area of the anode active material powder used in the surface-side active material layer having been changed to 7.0 m²/g. Furthermore, in example 4-5, an anode sheet was fabricated in a similar manner to example 4-2 with the exception of the average specific surface area of the anode active material powder used in the collector-side active material layer having been changed to 4.5 m²/g and the average specific surface area of the anode active material powder used in the surface-side active material layer having been changed to 7.0 m²/g. In addition, in example 4-6, an anode sheet was fabricated in a similar manner to example 4-3 with the exception of the average specific surface area of the anode active material powder used in the collector-side active material layer having been changed to 4.5 m²/g and the average specific surface area of the anode active material powder used in the surface-side active material layer having been changed to 7.0 m²/g.

Based on a thickness d1 of the collector-side active material layer, a thickness d2 of the surface-side active material layer, a specific surface area s1 of the anode active material in the collector-side active material layer, and a specific surface area s2 of the anode active material in the surface-side active material layer of the anode sheets obtained in the respective examples described above, an average specific surface area S of the anode active materials contained in the entire anode active material layer was calculated (S=[s1×d1/(d1+d2)+s2×d2/(d1+d2)]). Results of the calculation are shown in appropriate fields in table 1 below. The average specific surface area S of the anode active materials contained in the entire anode active material layer of the respective examples are within a range of 3.3 m²/g to 5.6 m²/g.

TABLE 1

| | ANODE | | | | | | | LITHIUM | HIGH- |
|---|---|---|---|---|---|---|---|---|---|
| | | | | COLLECTOR- | | SURFACE- | | DEPOSITION | TEMPERATURE |
| | | | ENTIRE | SIDE ACTIVE | | SIDE ACTIVE | | RESISTANCE | STORAGE |
| | PASTE | | ANODE | MATERIAL | | MATERIAL | | 0° C., | CHARACTERISTICS |
| | APPLICATION | | AVERAGE | LAYER | | LAYER | | 500 CYCLES | 60° C., |
| | QUANTITY | | SPECIFIC | SPECIFIC | THICK- | SPECIFIC | THICK- | LIMITING | 15 DAYS |
| | SINGLE | | SURFACE | SURFACE | NESS | SURFACE | NESS | CURRENT | CAPACITY |
| | SURFACE | DENSITY | AREA S | AREA s1 | d1 | AREA s2 | d2 | DENSITY | RETENTION |
| | mg/cm² | g/cm³ | m²/g | m²/g | μm | m²/g | μm | C RATE | % |
| EXAMPLE 1-1 | 2.9 | 1.0 | 3.3 | 2.5 | 24 | 7.0 | 5 | 14.9 | 91 |
| EXAMPLE 1-2 | 2.9 | 1.0 | 3.9 | 2.5 | 20 | 7.0 | 9 | 20.9 | 88 |
| EXAMPLE 1-3 | 2.9 | 1.0 | 4.4 | 2.5 | 17 | 7.0 | 12 | 25.3 | 87 |
| EXAMPLE 1-4 | 2.9 | 1.0 | 4.8 | 4.5 | 24 | 6.0 | 5 | 20.1 | 85 |
| EXAMPLE 1-5 | 2.9 | 1.0 | 5.0 | 4.5 | 20 | 6.0 | 9 | 23.9 | 84 |
| EXAMPLE 1-6 | 2.9 | 1.0 | 5.1 | 4.5 | 17 | 6.0 | 12 | 26.7 | 84 |
| EXAMPLE 2-1 | 2.9 | 1.4 | 3.6 | 2.5 | 16 | 7.0 | 5 | 16.1 | 90 |
| EXAMPLE 2-2 | 2.9 | 1.4 | 4.0 | 2.5 | 14 | 7.0 | 7 | 19.9 | 88 |
| EXAMPLE 2-3 | 2.9 | 1.4 | 4.4 | 2.5 | 12 | 7.0 | 9 | 23.6 | 86 |
| EXAMPLE 2-4 | 2.9 | 1.4 | 4.9 | 4.5 | 16 | 6.0 | 5 | 19.9 | 85 |
| EXAMPLE 2-5 | 2.9 | 1.4 | 5.0 | 4.5 | 14 | 6.0 | 7 | 22.3 | 84 |
| EXAMPLE 2-6 | 2.9 | 1.4 | 5.1 | 4.5 | 12 | 6.0 | 9 | 24.7 | 84 |
| EXAMPLE 3-1 | 7.0 | 1.0 | 3.3 | 2.5 | 60 | 8.0 | 10 | 22.0 | 91 |
| EXAMPLE 3-2 | 7.0 | 1.0 | 4.1 | 2.5 | 50 | 8.0 | 20 | 32.9 | 88 |
| EXAMPLE 3-3 | 7.0 | 1.0 | 4.9 | 2.5 | 40 | 8.0 | 30 | 43.9 | 85 |
| EXAMPLE 3-4 | 7.0 | 1.0 | 4.9 | 4.5 | 60 | 7.0 | 10 | 30.5 | 85 |
| EXAMPLE 3-5 | 7.0 | 1.0 | 5.2 | 4.5 | 50 | 7.0 | 20 | 38.0 | 83 |
| EXAMPLE 3-6 | 7.0 | 1.0 | 5.6 | 4.5 | 40 | 7.0 | 30 | 45.6 | 82 |
| EXAMPLE 4-1 | 7.0 | 1.4 | 3.3 | 2.5 | 43 | 8.0 | 7 | 19.8 | 91 |
| EXAMPLE 4-2 | 7.0 | 1.4 | 3.6 | 2.5 | 40 | 8.0 | 10 | 24.0 | 90 |
| EXAMPLE 4-3 | 7.0 | 1.4 | 4.2 | 2.5 | 35 | 8.0 | 15 | 30.9 | 87 |
| EXAMPLE 4-4 | 7.0 | 1.4 | 4.9 | 4.5 | 43 | 7.0 | 7 | 27.6 | 85 |
| EXAMPLE 4-5 | 7.0 | 1.4 | 5.0 | 4.5 | 40 | 7.0 | 10 | 30.5 | 84 |
| EXAMPLE 4-6 | 7.0 | 1.4 | 5.3 | 4.5 | 35 | 7.0 | 15 | 35.3 | 83 |

In addition, for comparison, anode active material powders having a same average specific surface area as the average specific surface area of the anode active materials contained in the entire anode active material layer obtained in the respective examples were prepared to fabricate anode sheets in which only a collector-side active material layer (single layer) is provided on an anode collector. Specifically, in comparative example 1-1, using an anode active material powder having a same average specific surface area as the average specific surface area (approximately 3.3 m²/g) of the anode active materials contained in the entire anode active material layer obtained in example 1-1, an anode sheet was fabricated in which only the collector-side active material layer 24a (single layer) is provided on the anode collector 22. A thickness of the collector-side active material layer (single layer) was adjusted so as to equal the total thickness (approximately 29 μm) that combines the thickness of the collector-side active material layer and the thickness of the surface-side active material layer in example 1-1. An anode sheet was fabricated with other conditions being the same as those in example 1-1 described above. The same applies for other comparative examples, the fabrication conditions of which are collectively shown in table 2 below.

TABLE 2

| | ANODE | | | | | | | | HIGH- |
|---|---|---|---|---|---|---|---|---|---|
| | | | | COLLECTOR- | | SURFACE- | | LITHIUM | TEMPERATURE |
| | | | | SIDE ACTIVE | | SIDE ACTIVE | | DEPOSITION | STORAGE |
| | | | ENTIRE | MATERIAL | | MATERIAL | | RESISTANCE | CHARACTER- |
| | PASTE | | ANODE | LAYER | | LAYER | | 0° C., | ISTICS |
| | APPLICATION | | AVERAGE | SPECIFIC | | SPECIFIC | | 500 CYCLES | 60° C., |
| | QUANTITY | | SPECIFIC | SURFACE | THICK- | SURFACE | THICK- | LIMITING | 15 DAYS |
| | SINGLE | | SURFACE | AREA | NESS | AREA | NESS | CURRENT | CAPACITY |
| | SURFACE | DENSITY | AREA S | s1 | d1 | s2 | d2 | DENSITY | RETENTION |
| | mg/cm² | g/cm³ | m²/g | m²/g | μm | m²/g | μm | C RATE | % |
| COMPARATIVE | 2.9 | 1.0 | 3.3 | 3.3 | 29 | — | — | 10.5 | 91 |
| EXAMPLE 1-1 | | | | | | | | | |
| COMPARATIVE | 2.9 | 1.0 | 3.9 | 3.9 | 29 | — | — | 13.0 | 88 |
| EXAMPLE 1-2 | | | | | | | | | |
| COMPARATIVE | 2.9 | 1.0 | 4.4 | 4.4 | 29 | — | — | 14.8 | 87 |
| EXAMPLE 1-3 | | | | | | | | | |
| COMPARATIVE | 2.9 | 1.0 | 4.8 | 4.8 | 29 | — | — | 16.4 | 85 |
| EXAMPLE 1-4 | | | | | | | | | |
| COMPARATIVE | 2.9 | 1.0 | 5.0 | 5.0 | 29 | — | — | 17.2 | 84 |
| EXAMPLE 1-5 | | | | | | | | | |
| COMPARATIVE | 2.9 | 1.0 | 5.1 | 5.1 | 29 | — | — | 17.9 | 84 |
| EXAMPLE 1-6 | | | | | | | | | |
| COMPARATIVE | 2.9 | 1.4 | 3.6 | 3.5 | 21 | — | — | 10.6 | 90 |
| EXAMPLE 2-1 | | | | | | | | | |
| COMPARATIVE | 2.9 | 1.4 | 4.0 | 4.0 | 21 | — | — | 12.2 | 88 |
| EXAMPLE 2-2 | | | | | | | | | |
| COMPARATIVE | 2.9 | 1.4 | 4.4 | 4.4 | 21 | — | — | 13.7 | 86 |
| EXAMPLE 2-3 | | | | | | | | | |
| COMPARATIVE | 2.9 | 1.4 | 4.9 | 4.9 | 21 | — | — | 15.3 | 85 |
| EXAMPLE 2-4 | | | | | | | | | |
| COMPARATIVE | 2.9 | 1.4 | 5.0 | 5.0 | 21 | — | — | 15.8 | 84 |
| EXAMPLE 2-5 | | | | | | | | | |
| COMPARATIVE | 2.9 | 1.4 | 5.1 | 5.1 | 21 | — | — | 16.3 | 84 |
| EXAMPLE 2-6 | | | | | | | | | |
| COMPARATIVE | 7.0 | 1.0 | 3.3 | 3.3 | 70 | — | — | 15.7 | 91 |
| EXAMPLE 3-1 | | | | | | | | | |
| COMPARATIVE | 7.0 | 1.0 | 4.1 | 4.1 | 70 | — | — | 20.4 | 88 |
| EXAMPLE 3-2 | | | | | | | | | |
| COMPARATIVE | 7.0 | 1.0 | 4.9 | 4.9 | 70 | — | — | 25.1 | 85 |
| EXAMPLE 3-3 | | | | | | | | | |
| COMPARATIVE | 7.0 | 1.0 | 4.9 | 4.9 | 70 | — | — | 25.1 | 85 |
| EXAMPLE 3-4 | | | | | | | | | |
| COMPARATIVE | 7.0 | 1.0 | 5.2 | 5.2 | 70 | — | — | 27.2 | 83 |
| EXAMPLE 3-5 | | | | | | | | | |
| COMPARATIVE | 7.0 | 1.0 | 5.6 | 5.6 | 70 | — | — | 29.4 | 82 |
| EXAMPLE 3-6 | | | | | | | | | |
| COMPARATIVE | 7.0 | 1.4 | 3.3 | 3.3 | 50 | — | — | 14.2 | 91 |
| EXAMPLE 4-1 | | | | | | | | | |
| COMPARATIVE | 7.0 | 1.4 | 3.6 | 3.6 | 50 | — | — | 16.0 | 90 |
| EXAMPLE 4-2 | | | | | | | | | |
| COMPARATIVE | 7.0 | 1.4 | 4.2 | 4.2 | 50 | — | — | 19.0 | 87 |
| EXAMPLE 4-3 | | | | | | | | | |
| COMPARATIVE | 7.0 | 1.4 | 4.9 | 4.9 | 50 | — | — | 22.8 | 85 |
| EXAMPLE 4-4 | | | | | | | | | |
| COMPARATIVE | 7.0 | 1.4 | 5.0 | 5.0 | 50 | — | — | 23.6 | 84 |
| EXAMPLE 4-5 | | | | | | | | | |
| COMPARATIVE | 7.0 | 1.4 | 5.3 | 5.3 | 50 | — | — | 24.9 | 83 |
| EXAMPLE 4-6 | | | | | | | | | |

<Construction of Lithium-Ion Battery>

Test lithium-ion batteries were constructed using the anode sheets fabricated as described above according to the examples and comparative examples. A high-rate pulse charge-discharge test was performed on each test battery and a battery performance thereof was evaluated. Moreover, the test lithium-ion batteries were fabricated as described below.

A cathode active material layer paste was prepared by mixing lithium nickel cobalt manganese oxide (LiNi_{1/3}CO_{1/3}Mn_{1/3}O₂) powder as a cathode active material, acetylene black as a conductive material, and polyvinylidene fluoride (PVDF) as a binder in N-methylpyrrolidone (NMP) so that the materials have a mass ratio of 87:10:3, and by applying the cathode active material layer paste in a band-shape to both surfaces of an elongated sheet-shaped aluminum foil (the cathode collector 12) and drying the same, the cathode sheet 10 in which the cathode active material layer 14 is provided on both surfaces of the cathode collector 12 was fabricated. In example 1-1 to example 1-6, example 2-1 to example 2-6, comparative example 1-1 to comparative example 1-6, and comparative example 2-1 to comparative example 2-6, an application amount of the cathode active material layer paste was adjusted to approximately 6.1 mg/cm² per one surface. In addition, in example 3-1 to example 3-6, example 4-1 to example 4-6, comparative example 3-1 to comparative example 3-6, and comparative example 4-1 to comparative example 4-6, two types of cathode sheets 10 respectively adjusted to approximately 10.1 mg/cm² and approximately 14.7 mg/cm² per one surface were prepared.

A cathode was fabricated by punching out a 3 cm×4 cm square from the cathode active material layer of the obtained cathode sheet. In addition, an anode was fabricated by punching out a 3 cm×4 cm square from the anode active material layer of the obtained anode sheet. An aluminum lead was attached to the cathode, a nickel lead was attached to the anode, and the cathode and the anode were arranged so as to oppose each other via a separator (a porous polypropylene sheet was used) and were inserted into a laminated bag together with a nonaqueous electrolyte to construct a laminated cell 60 shown in FIG. 6. The constructed laminated cell was sandwiched between SUS (stainless steel) plates and subjected to a load of 350 kgf. In FIG. 6, reference numeral 61 denotes a cathode, 62 denotes an anode, 63 denotes a separator impregnated with an electrolyte, and 64 denotes a laminated bag. Moreover, a nonaqueous electrolyte was used in which LiPF₆ as a supporting electrolyte is contained at a concentration of approximately 1 mol/liter in a mixed solvent containing EC (ethylene carbonate), DMC (dimethyl carbonate), and EMC (ethyl methyl carbonate) at a volume ratio of 3:4:3. Subsequently, an initial charging and discharging process (conditioning) was performed by an ordinary method to obtain a test lithium-ion battery.

<Initial Capacity Measurement>

Each of the lithium-ion batteries of the respective examples fabricated in this manner was charged at 25° C. by a constant current/constant voltage method at a current of 1 C and a voltage of 4.1 V for a total charging period of 3 hours. After a rest period of 10 minutes, the charged battery was discharged at 25° C. by a constant current and constant voltage method of ⅓ C until 3 V for a total discharging period of 3 hours, and a discharge capacity at this point was measured as an initial capacity.

<High-Rate Pulse Charge-Discharge Test>

In addition, a charge-discharge cycle tests was performed by applying a charge-discharge pattern in which high-rate pulse charge and discharge are repeated on each of the lithium-ion batteries. Specifically, after charging so that a state of charge (SOC) of the battery reaches 60% of the initial capacity, in an 0° C. environment, a charge-discharge cycle involving performing a high-rate pulse charge at 10 C for 10 seconds, performing a high-rate pulse discharge at 10 C for 10 seconds, and resting for 10 minutes was continuously repeated 500 times. A discharge capacity after the charge-discharge cycle test was obtained by the same method as the initial capacity measurement, and based on the discharge capacity after the charge-discharge cycle test and the initial capacity, a capacity retention after the charge-discharge cycle test (=[discharge capacity after charge-discharge cycle test/initial capacity]×100) was calculated.

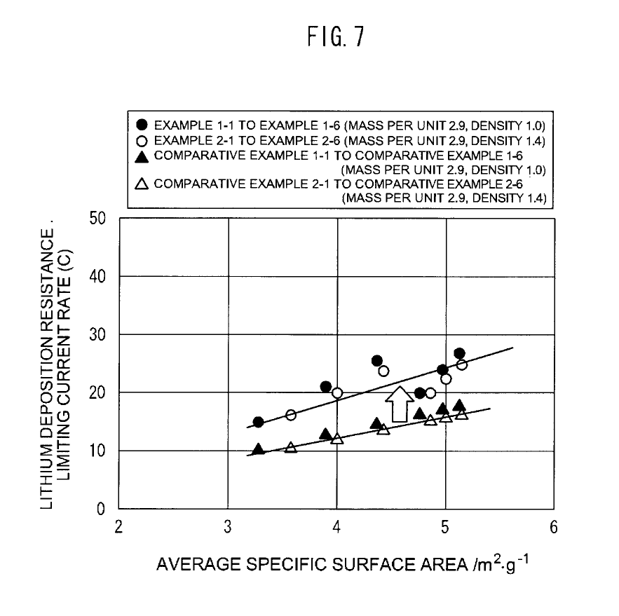

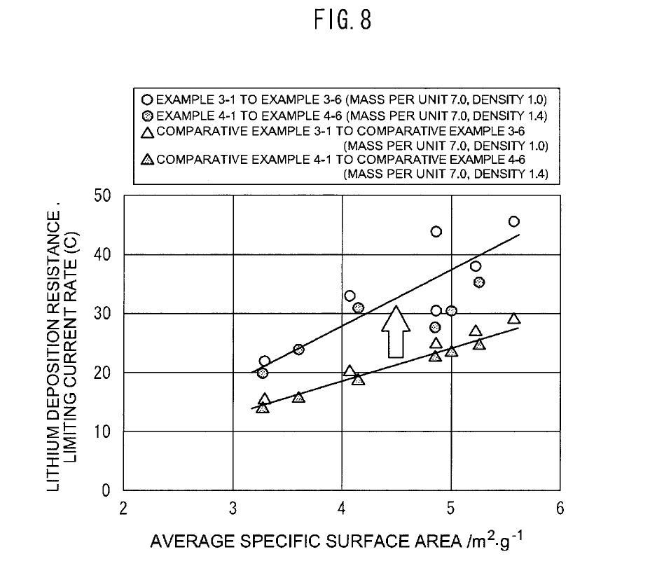

In addition, the charge-discharge cycle test was performed while increasing current values from 10 C to 50 C in small increments, and a current value at a point where the capacity retention after the charge-discharge cycle test initially falls below 98% was obtained as a limiting current rate. Results thereof are shown in table 1 and table 2 and in FIGS. 7 and 8. FIGS. 7 and 8 are graphs representing relationships between an average specific surface area (m²/g) of the anode active materials contained in the entire anode active material layer and an limiting current rate (C).

As shown in FIGS. 7 and 8, the batteries according to the respective examples have a higher limiting current rate than the batteries according to the respective comparative examples, and have a distinctly improved durability against high-rate charge-discharge cycles. Since the phenomenon described above was observed in batteries according to the examples even though the average specific surface area of the anode active materials contained in the entire anode active material layer was more or less equal to that in the comparative examples, it may be argued that providing an appropriate difference in the average specific surface area of the anode active materials between the surface side and the collector side of the anode active material layer has significantly contributed to the improvement in durability against high-rate charge-discharge cycles. In other words, since an increase in the specific surface area of the anode active material increases the reactivity of the anode active material (typically, the activity of a Li ion insertion reaction) and suppresses the deposition of lithium, arranging a large quantity of the anode active material with a large specific surface area on the surface side conceivably enables the deposition of lithium on the surface side attributable to high-rate charge-discharge to be suppressed and durability against high-rate charge-discharge cycles to be improved.

<High-Temperature Retention Characteristics Test>

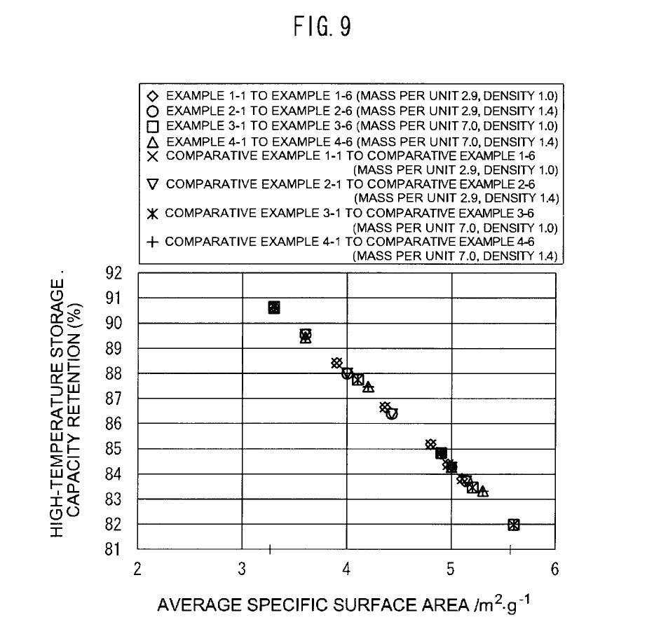

Furthermore, each of the lithium-ion batteries described above was subjected to a high-temperature storage test performed at 60° C. for 15 days. Specifically, after charging a battery so that a state of charge thereof reached 80% of an initial capacity, the battery in the charged state was stored in a 60° C. environment for 15 days. A discharge capacity after the high-temperature storage test was obtained by the same method as the initial capacity measurement, and based on the discharge capacity after the high-temperature storage test and the initial capacity, a capacity retention (=[discharge capacity after high-temperature storage/initial capacity]×100) was calculated. Results thereof are shown in table 1 and table 2 and in FIG. 9. FIG. 9 is a graph representing a relationship between an average specific surface area (m²/g) of the anode active materials contained in the entire anode active material layer and capacity retention (%). In table 1 and table 2, capacity retention is shown rounded off to the nearest whole number.

As shown in FIG. 9, the batteries according to the examples were able to achieve a high capacity retention more or less equivalent to that of the batteries according to the comparative examples even with the average specific surface area of the anode active material on the surface side being increased in comparison to the comparative examples. Specifically, by adjusting the average specific surface area of the anode active materials contained in the entire anode active material layer to 3.3 m²/g to 5.6 m²/g, a significantly high capacity retention of 80% or higher was achieved. These results confirmed that high-temperature storage characteristics and durability against high-rate charge-discharge cycles can be simultaneously achieved at a high level by providing an appropriate difference in the specific surface areas of the anode active materials between the surface side and the collector side of the anode active material layer and by adjusting the average specific surface area S of the anode active materials contained in the entire anode active material layer to 3.3 m²/g to 5.6 m²/g. From the perspective of improving high-temperature storage characteristics, the average specific surface area of the anode active materials contained in the entire anode active material layer is appropriately set to 5.6 m²/g or less, favorably set to, for example, 5.0 m²/g or less, more favorably set to, for example, 4.5 m²/g or less, and further favorably set to, for example, 4.0 m²/g or less.

While the present invention has been described in its preferred embodiment, it is to be understood that the present invention is not limited to such description and that various modifications can be made.

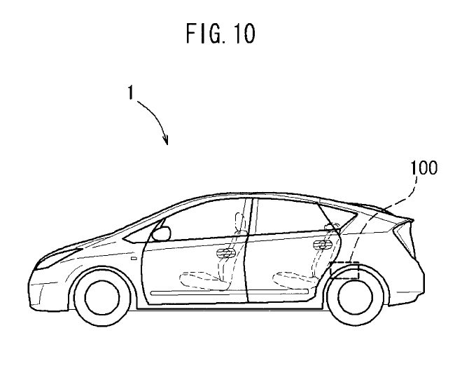

Moreover, any of the lithium secondary batteries 100 disclosed herein has a property suitable as a battery mounted on a vehicle and, in particular, are superior in durability against high-rate charge-discharge. Therefore, according to the present invention, as shown in FIG. 10, a vehicle 1 mounted with any of the lithium secondary batteries 100 disclosed herein is provided. In particular, a vehicle (for example, an automobile) comprising the lithium secondary battery 100 as a power source (typically, a power source of a hybrid vehicle or an electric vehicle) is provided.

Furthermore, examples of favorable objects of application of the techniques disclosed herein include: a lithium secondary battery which can conceivably be used in a charge-discharge cycle including a high-rate charge-discharge of 50 A or higher (for example, 50 A to 250 A) and, more specifically, 100 A or higher (for example, 100 A to 200 A); and a high-capacity lithium secondary battery which has a theoretical capacity of 3 Ah or greater (more specifically, 5 Ah or greater) and which can conceivably be used in a charge-discharge cycle including a high-rate charge-discharge of 10 C or higher (for example, 10 C to 50 C), more specifically, 12 C or higher (for example, 12 C to 45 C), and further specifically 20 C or higher (for example, 20 C to 45 C).

### INDUSTRIAL APPLICABILITY

According to configurations of the present invention, a lithium secondary battery with improved durability against high-rate charge-discharge can be provided.

1. A lithium secondary battery comprising a cathode and an anode, wherein
the anode is structured such that an anode active material layer containing graphite materials as anode active materials is retained on an anode collector,
the anode active material layer has a structure of at least two layers: a collector-side active material layer provided on the anode collector; and a surface-side active material layer provided on the collector-side active material layer,
an average specific surface area of the graphite material contained in the surface-side active material layer is greater than an average specific surface area of the graphite material contained in the collector-side active material layer,
an average specific surface area of the graphite materials contained in the entire anode active material layer is 3.3 m²/g to 5.6 m²/g,
the average specific surface area of the graphite material contained in the surface-side active material layer is 6.0 m²/g to 8.0 m²/g, and
the average specific surface area of the graphite material contained in the collector-side active material layer is 2.5 m²/g to 4.5 m²/g.

2. The lithium secondary battery according to claim 1, wherein
the average specific surface area of the graphite materials contained in the entire anode active material layer is 5.0 m²/g or more.

3. (canceled)

4. The lithium secondary battery according to claim 1, wherein
a mass of the anode active material contained in the surface-side active material layer is 15 percent by mass to 45 percent by mass with respect to a total mass of the anode active materials contained in the entire anode active material layer.

5. (canceled)

6. An anode for a lithium secondary battery, the anode being structured such that an anode active material layer containing graphite materials as anode active materials is retained on an anode collector, wherein
the anode active material layer has a structure of at least two layers: a collector-side active material layer provided on the anode collector; and a surface-side active material layer provided on the collector-side active material layer,
an average specific surface area of the graphite material contained in the surface-side active material layer is greater than an average specific surface area of the graphite material contained in the collector-side active material layer,
an average specific surface area of the graphite materials contained in the entire anode active material layer is 3.3 m²/g to 5.6 m²/g,
the average specific surface area of the graphite material contained in the surface-side active material layer is 6.0 m²/g to 8.0 m²/g, and
the average specific surface area of the graphite material contained in the collector-side active material layer is 2.5 m²/g to 4.5 m²/g.

7. A vehicle mounted with the lithium secondary battery according to claim 1.
